(19) United States
(12) Patent Application Publication
(10) Pub. No.: US 2006/0199243 A1
(43) Pub. Date: Sep. 7, 2006

(54) Cytological stain composition and methods of use

(76) Inventors: David M. Garner, Vancouver (CA); Cedomirka Todorovic, Vancouver (CA); Winnie E. Lee, Burnaby (CA)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/073,305

(22) Filed: Mar. 3, 2005

(51) Int. Cl. G01N 1/30

(52) U.S. Cl. 435/40.5

(57) ABSTRACT

An aqueous staining reagent is described, a composition of a stain, a metal metabisulfite, and acid in water. The stain can be a cationic stain and is preferably thionin. The metal metabisulfite is preferably sodium metabisulfite. A method of preparing the aqueous staining reagent is described. Cytological methods for imaging cells stained by the aqueous staining reagent are described. A kit for cellular analysis is described.

### BACKGROUND OF THE INVENTION

The present invention relates to the field of visualizing and quantifying DNA. The invention relates more specifically to the field of cytological stains for use with cellular DNA. The invention furthermore relates to the field of cytological analysis of DNA for uses such as detection of diseases.

Since the discovery of a cellular blueprint, DNA and its role in determining the structure, function and characteristics of cells has gained importance. Various DNA abnormalities are manifested in phenotypic and functional changes, which are frequently associated with disease. Quantification of DNA content and/or DNA distribution in individual cells or groups of cells, such as those in cytological preparations, provides a means to screen for diseases, such as cancer.

Image cytometry is one technique that can be applied to measure cellular DNA to determine if cells have abnormal DNA content. DNA quantitation continues to be widely used in pathology and cytopathology to detect disease or obtain other diagnostic and/or prognostic information. In addition to the amount of DNA, DNA distribution in cell nuclei can be utilized in diagnostic protocols. U.S. Pat. No. 6,348,325 to Zahniser, Cytological Stain Composition, for example, discusses devices and cellular features for assessing DNA. DNA distribution is also discussed in United States Published Patent Application No. 2004/0092026, Method of Identifying and Assessing DNA Euchromatin in Biological Cells for Detecting Disease, Monitoring Wellness, Assessing Bio-Activity, and Screening Pharmacological Agents, the disclosure of which is incorporated herein by reference.

Imaging DNA generally requires that the DNA be stained for visual enhancement. DNA quantitation is best accomplished using stoichiometric staining methods establishing a direct, proportional relationship between staining intensity (stain uptake) and DNA amount. A variety of dyes and DNA staining methods have been developed over the last several decades.

The use of dyes is not exclusive to staining cellular DNA for imaging. Dyes are also used as colorants for wood, textiles, food, pharmaceuticals and cosmetics. Some examples of water-soluble dyes include thionin, cresyl violet, carmine, red number 40, and Alcian blue. Numerous stains used for visualizing proteins, enzymes, and cell organelles as well as DNA. Qualitative stains suggested for staining DNA encompass hematoxylin, acridine orange, methyl green, Giemsa, and antibody binding and fluorescent stains. Dyes specifically applied to stain DNA using the Feulgen staining reaction, discussed below, have included thionin, Azure A and C, methylene blue, acriflavin and pararosaniline.

Feulgen and Voit are credited for discovering a reaction in 1924 involving the acid hydrolysis of fixed tissues, oxidizing deoxypentose sugars in DNA to generate free aldehyde groups. The subsequent addition of a Schiff or Schiff-like reagent forms covalent bonds with these free aldehyde groups to yield a detectable coloured product that displays the presence of DNA. The stoichiometric nature of the reaction directly relates the intensity of the coloured product to the amount of DNA present. Manual or automated analysis conducted on the nuclear optical density of stained cellular material is used to determine the amount of DNA present. A variety of the aforementioned stains such as Azure A, Azure C, pararosaniline and cresyl violet has been investigated for use in the Feulgen reaction. A cationic stain, thionin, is commonly used because of its specificity in clearly contrasting nuclear DNA from cell cytoplasm to facilitate automated image analysis and quantification.

The Feulgen reaction was useful for intracellular DNA quantitation, but the solubility of thionin is somewhat limiting. Van Duijn suggested that the long staining time necessary for satisfactory results was caused by an insufficient excess of the active component in the mixture, a cause not unlikely since a relatively great part of the dye precipitated from the solution. Van Duijn, P. A Histochemical Specific Thionine-SO2 Reagent and its Use in a Bicolor Method for Deoxyribonucleic Acid and Periodic Acid Schiff Positive Substances, Journal of Histochemistry and Cytochemistry (1956) Vol. 4:1, pp. 56-63. Certainly, precipitation will cause a decrease in the histochemical activity of the stain. Van Duijn therefore proposed the use of tertiary butyl alcohol to increase the solubility of the thionine-sulfite salt. This method was adopted by researchers. For example, in a test of various stains used in image cytometry, thionin was prepared in tertiary butanol. Mikel U., Becker, R. Jr. A Comparative Study of Quantitative Stains for DNA in Image Cytometry, Analytical and Quantitative Cytology and Histology, August 1991, Vol. 13: 4, pp. 253-260.

The use of other alcohols, such as methanol, ethanol, n-propanol, isopropanol, or mixtures thereof, has been described to increase solubility. See, for example, U.S. Pat. No. 6,593,102 to Zahniser, Cytological Stain Composition, at column 8, lines 7-9; and U.S. Pat. No. 5,942,410 to Lam, Composition and Methods for Staining Cellular DNA, Comprising Thiazine Derivative Metabisulfite and Methanol or Ethanol, at column 4, lines 4 through 21.

A representative prior art staining procedure is shown in block diagram form in FIG. 1A. The procedure for staining cells mounted on a microscope slide, using tertiary-butanol-formulated thionin stain, was:
Fixation of tissues in Bohm Sprenger's fixative for 30-60 minutes (320 mL methanol, 60 mL aqueous 37% formaldehyde solution, 20 mL glacial acetic acid) (step 5);
Distilled water rinse;
Acid hydrolysis in 5N hydrochloric acid at room temperature (step 10);
Distilled water rinse;
Staining with thionin in tertiary butanol (step 15) (0.5 grams thionin, 435 mL distilled water, boiled for five minutes and cooled, 435 mL tertiary butanol, 130 mL 1N hydrochloric acid, add 8.7 grams sodium metabisulfite, stir bar, and stir for at least one hour; filter before use; immerse specimen in stain for 75 minutes);
Distilled water rinse;
Rinse solution (step 20) (7.5 grams sodium metabisulfite in 1425 mL of distilled water, 75 mL 1N hydrochloric acid, three changes of rinse solution with 20 dips per dish of rinse);
Distilled water rinse;
Alcohol dehydration (step 25) (three graded alcohol dehydration steps, slides immersed in xylene until ready for next step); and
Mounting slides in mounting media, apply cover slip (step 30)

The procedure for staining cells mounted on a microscope slide, acid-alcohol-formulated thionin stain, was:
Fixation of tissues in Bohm Sprenger's fixative for 30-60 minutes (320 mL methanol, 60 mL aqueous 37% formaldehyde solution, 20 mL glacial acetic acid) (step 5);
Distilled water rinse;
Acid hydrolysis in 5N hydrochloric acid at room temperature (step 10);
Distilled water rinse;
Staining with aqueous thionin stain solution (step 15) (0.5 grams thionin, 0.5 grams sodium metabisulfite, 200 mL methanol, 250 mL distilled water, 50 mL 1N hydrochloric acid, stir for one hour, filter through No. 1 grade filter paper, immerse specimen in stain for 75 minutes);
Distilled water rinse;
Rinse solution (step 20) (7.5 grams sodium metabisulfite in 1425 mL of distilled water, 75 mL 1N hydrochloric acid, three changes of rinse solution with 20 dips per dish of rinse);
Distilled water rinse;
Alcohol dehydration (step 25) (three graded alcohol dehydration steps, slides immersed in xylene until ready for next step); and
Mounting slides in mounting media, apply cover slip (step 30)

The cost of alcohol reagents and their physical and chemical characteristics cause inconveniences and hazards for users. The use of alcohols causes challenges in safety, shipping, and expense. For example, tertiary butanol is inconvenient not only because it is solid at room temperature, but also because it requires significant safety precautions and equipment. Extended time is required for preparation of alcohol-based stains. Alcohols are, of course, flammable and poisonous, causing hazards to laboratory personnel and the need for protective equipment.

It is also both safer and more convenient to ship and handle reagents that are not flammable. The aqueous composition of the present invention omits expensive alcohols and allows fresh reagents to be made and disposed of quickly and easily. Reducing complications and precautions generally provides an opportunity for cost saving both in supplying products to markets as well as when they are incorporated into a laboratory testing method. In some instances, cells may be prepared at one location and may be shipped in solution to another facility for analysis, for example.

Accordingly, a need exists for a DNA stain that offers fewer hazards in preparation, shipping, and use. A need also exists for a DNA stain that can be easily prepared. The present invention meets these needs.

### BRIEF SUMMARY OF THE INVENTION

The present invention comprises a cytological stain and methods of use of that stain, including, for example, staining of cellular DNA. The present invention is in one respect an aqueous staining reagent that employs alternative methods to increase stain solubility, and therefore limit precipitation, without alcohol. The aqueous staining reagent provides the opportunity for safer, faster, simpler, and consequently more effective staining. The stain composition and methods represent improvements in visualizing and quantifying DNA for uses including disease detection. In another aspect, a method for staining cellular DNA is provided, using the composition of the present invention. The method includes an approach of detecting and quantifying cellular DNA by providing stained nuclei for measurement. The integrated optical density of stained nuclei is one such measurement. The analysis of cellular chromatin and euchromatin, stained with the aqueous staining reagent, is another aspect of the present invention.

The composition of the preferred embodiment of the staining reagent of the present invention is an aqueous solution of a stain and a metal metabisulfite. The stain is preferably a cationic stain. In the preferred embodiment, the stain is thionin, preferably of the form of 3,7-diamino-5-phenothiazinium acetate. The metal metabisulfite is preferably sodium or potassium, preferably sodium. The components are preferably mixed in a one-to-one ratio in distilled water at 26° C. and filtered.

In another respect, the present invention is a method of Feulgen staining. Tissues to be stained are fixed, preferably in Bohm Sprenger's fixative, hydrolyzed at 26° C. in 5N hydrochloric acid, stained with the aqueous staining reagent of the present invention, rinsed, dehydrated, and mounted.

In yet another respect, the present invention comprises measuring optical density of nuclei stained with the aqueous staining reagent of the present invention.

In yet another respect, the present invention comprises a cellular DNA staining kit.

In yet another respect, the composition and method of the present invention is used to stain components of DNA such as chromatin and euchromatin.

It is an object of the present invention to reduce the risks and inconveniences previously associated with alcohol-containing stains. Difficulties such as the explosion potential of tertiary butanol, loss of solution volume, and the ease of fume liberation by volatile alcohol solutions, are be reduced by use of an aqueous staining solution. Such a solution may also overcome increasing concerns over shipping flammable materials with tighter restrictions and continual increases in shipping costs and precautionary measures. Additionally, an aqueous solution provides sufficient stability to allow thionin to be supplied in liquid form, further simplifying the staining process. Accordingly, it is an objective of the present invention to improve safety by eliminating alcohol from DNA-staining methods and formulations.

Another object of the present invention is to simplify preparations by removing the need to boil solutions. The low-temperature preparation method disclosed herein will reduce the generation of noxious fumes and vapours such as sulphur dioxide associated with some DNA staining methods, reducing hazards to personnel and eliminating the need for some protective equipment. Solution loss due to evaporation may also allow smaller quantities of reagents than previous formulations requiring a boiling step.

Yet another object of the present invention is to reduce stirring time in comparison to other stain formulations. In the absence of boiling and with shorter stirring time, preparation procedures for the present invention requires approximately one hour. Accordingly, fresh stain may be prepared and used for cellular staining during one working day. Advantages include performance of fresh stain and a reduced need to track and store reagents.

Yet another goal of the present invention is to provide a DNA staining composition that accomplishes stoichiometric DNA staining to support measuring the amount and distribution of cellular DNA.

Yet another object of the present invention is to support standardization to sustain consistency essential for effective, reproducible quantification.

Accordingly, advantages of the new stain composition and methods may include safety, convenience, and improved performance.

### BRIEF DESCRIPTION OF THE SEVERAL VIEWS OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1A is a block diagram of a DNA staining method as is known in the prior art.

FIG. 1B is a block diagram of a staining procedure of an embodiment of the present invention, using an aqueous staining reagent.

FIG. 2 is a block diagram of the method of preparation of the aqueous staining reagent of the preferred embodiment of the present invention.

FIG. 3 is a table to show mass of thionin and metabisulfite along with intensity values.

FIG. 4 is an illustration of a DNA staining kit incorporating the aqueous staining reagent of the preferred embodiment of the present invention.

### DETAILED DESCRIPTION OF THE PREFERRED EMBODIMENT OF THE INVENTION

While the invention may be susceptible to embodiments in different forms, there is shown in the drawings, and herein will be described in detail, specific embodiments with the understanding that the present disclosure is to be considered an exemplification of the principles of the invention, and is not intended to limit the invention to that as illustrated and described herein.

The present invention in one embodiment is an aqueous staining reagent for the Feulgen reaction for staining cellular DNA. (The term “aqueous” as used herein with reference to a solution means having water as the primary solvent and not having an amount of alcohol effective to change the solubility of any solute in the solution.) The reagent includes a stain and a metal metabisulfite, dissolved in distilled water.

The stain of the composition is preferably cationic. In the preferred embodiment, the stain is thionin, preferably of the form of 3,7-diamino-5-phenothiazinium acetate. The stain component can also be Azure A, Azure B, Azure C, sym-dimethylthionine, pararosanilin, methylene blue, fuchsin, hematoxylin, acridine orange, or methyl green.

The metal of the metal metabisulfite is preferably sodium or potassium, preferably sodium.

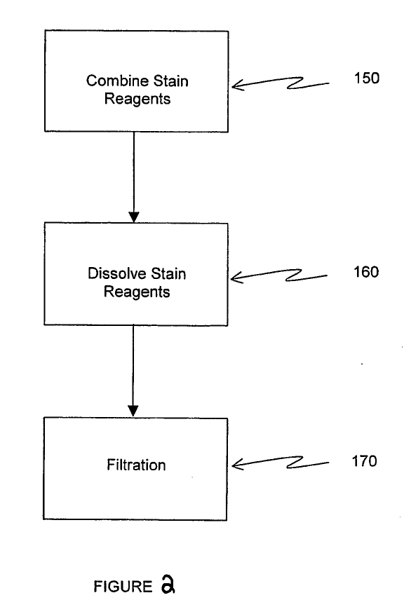

The preferred method of producing the aqueous staining reagent of the present invention is depicted in block diagram form in FIG. 2. The method will be described for the preferred embodiment in which thionin is the stain and sodium metabisulfite is the metal metabisulfite. A similar procedure can be used for preparing Feulgen staining reagents using other stains, including the other cationic stains described above, or using a different metal metabisulfite, without departing from the spirit of the present invention.

The method begins with the addition of 50 mL of 1N acid to 450 mL of distilled water (step 150). In the preferred embodiment, the acid is hydrochloric acid. Please note that, alternatively, acetic acid, nitric acid, phosphoric acid, sulfuric acid, or other appropriate acid can be used.

Next, 1.0 gram of thionin and 1.0 gram of sodium metabisulfite are added to the acid-water mix and the mixture is stirred (step 160) to dissolve the reagents. After an appropriate time period, as discussed below, the solution is filtered (step 170).

The reagent thionin can be obtained as a purple solid dye of variable purity. A representative reagent used in the preferred embodiment of the invention is available through the Aldrich Chemical Company, Milwaukee, Wis., with a dye content substantially comprised of thionin dye. An acceptable weight per volume ratio of thionin in the aqueous staining reagent is between 0.05 to 0.6%, and preferably about 0.2%. The resulting concentration of thionin in the composition is between 1.5×10⁻³ M and 2.5×10⁻² M, preferably about 7.0×10⁻³ M.

The metabisulfite used in the preferred embodiment of the invention is available as a white crystalline solid ACS (American Chemical Society) reagent containing primarily sodium metabisulfite, such as the product available through the Sigma Aldrich Chemical Company, in St. Louis, Mo. The weight per volume ratio of sodium metabisulfite in the aqueous staining reagent is between 0.05% and 2.4%, and preferably 0.2%. The resulting molarity of sodium metabisulfite in the composition is between 2.5×10⁻³ and 1.5×10⁻¹ M, preferably 1.0×10⁻² M.

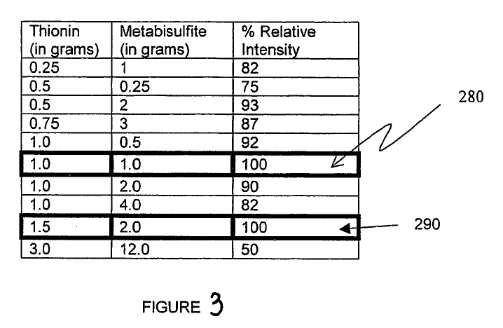

Varying amounts of sodium metabisulfite and thionin, dissolved in distilled water in a conventional slide-staining vessel holding 500 mL of solution, and the resulting relative maximum intensity at each ratio, are shown in FIG. 3. As can be seen, the best results occur at two different ratios: (1) 1.0 gram of thionin and 1.0 gram of metabisulfite (line 280 of FIG. 3), and (2) 1.5 grams of thionin and 2.0 grams of metabisulfite (line 290 of FIG. 3). Both ratios yield high stain intensities. In practice the ratio shown at line 280 is preferred, because an amount of 1.0 gram of each reagent is easily recalled and more convenient to measure in comparison to other rations. Accordingly, in the preferred embodiment, the composition of the invention mixes 1.0 gram of thionin with 1.0 gram of sodium metabisulfite in 500 mL in an aqueous solution. Other ratios, however, can be used with satisfactory stain intensity.

Using the preferred amounts, the resulting mixture is a solution with a pH between about 1.3 and 1.5. The molar ratio of sodium metabisulfite to thionin used in the present invention is comparable to the ratio found, for example, in the alcohol formulation described in Lam '410, but without the use of alcohol in the composition.

Those skilled in the art will recognize temperature, insufficient mixing, and contaminants as a few possible factors leading to the formation of precipitates. In an effort to maximally dissolve active DNA staining materials into the working solution, it is necessary to find a stirring method (for step 160) that is reliable, consistent and simple. In the event of insufficient stirring, precipitation of stain crystals may occur. Precipitation is undesirable due to the danger of lower staining intensity, as discussed above, possibly caused by leaving fewer active DNA-staining elements in the remaining working solution. Granules of precipitate may adhere or overlay cells and complicate the accuracy of DNA assessment. Stain variation, which can be caused by precipitation, presents problems in quantification using image analysis by creating differences in the degree of stain uptake and the optical density of the stained objects.

Consistent stirring times and rates may further reduce variability by providing a standard of reliable and measurable guidelines to support batch consistency. Overhead stirring is an example of one such method. One example of a standard used with the present composition is stirring for one hour at 200 rpm. The speed of mixing is measurable using a tachometer if overhead stirring is used.

Ambient laboratory temperatures may fluctuate and cause the cooling of staining reagents, which also promotes precipitation of the staining solution. As a result, an efficient way of maintaining temperature is needed without creating additional difficulties. For example, overheating will cause evaporation of the solution, and therefore will vary the concentration or reagent solubility. Overheating is a problem with alcohol-based solutions, since those solutions have a higher vapour pressure than the aqueous solution of the present invention. The stability of an aqueous stain reagent, unlike alcohol mixtures, allows the staining solution to be regulated above typical room temperature without extensive evaporation. Temperatures of about 24 to 27° C. are easily maintained by warming equipment without great hazards or expense. Preferentially, the temperature of a staining procedure using the above composition is 26° C.

Temperature maintenance across all liquid reagents prior to preparation of the staining solution is also needed to reduce the possibility of cooling of the staining solution. One way of achieving temperature maintenance is to use a regulated heated environment such as a water bath. In the preferred embodiment, reagents are warmed for at least one-hour prior to use to ensure all liquids reach the desired temperature. A time of one hour for stirring the composition coincides with the minimum amount of time needed to warm other working reagents. This time frame is efficient since both stirring and warming of staining reagents are completed while giving time for other working solutions to be prepared. The preparation time of one hour allows the entire staining process to be accomplished well within one working day.

Insoluble solid particles remaining after stain production steps 150 and 160 of FIG. 3 are removed in step 170. Generally, separation techniques are used to remove particles that may contaminate or cause precipitation of the solution. Temperature changes or particles providing a lattice for crystal production may promote precipitation. Accordingly, techniques used to remove particulate matter from the aqueous staining reagent need to be easy and quick to use to avoid extensive cooling. Some separation techniques include the use of gradient filtration, pressure filtration, gravitational filtration, suction filtration, and distillation. Of these techniques, filtration provides a method of separation that removes large particles easily and quickly.

Preferentially, suction filtration is used with the aqueous staining reagent of the present invention. In suction filtration, the stain is poured into a funnel lined by filter paper with 6 μm particle retention while subjected to negative pressure. A pump, vacuum line or a water aspiration system may be used to generate negative pressure. Suction filtration provides a relatively inexpensive, safe and easy way of shortening separation time.

The method of staining cells using the aqueous staining reagent described herein, prepared as described above, will now be described. The same method of staining cells can be used with compositions prepared with other stains described above or with other metal metabisulfites.

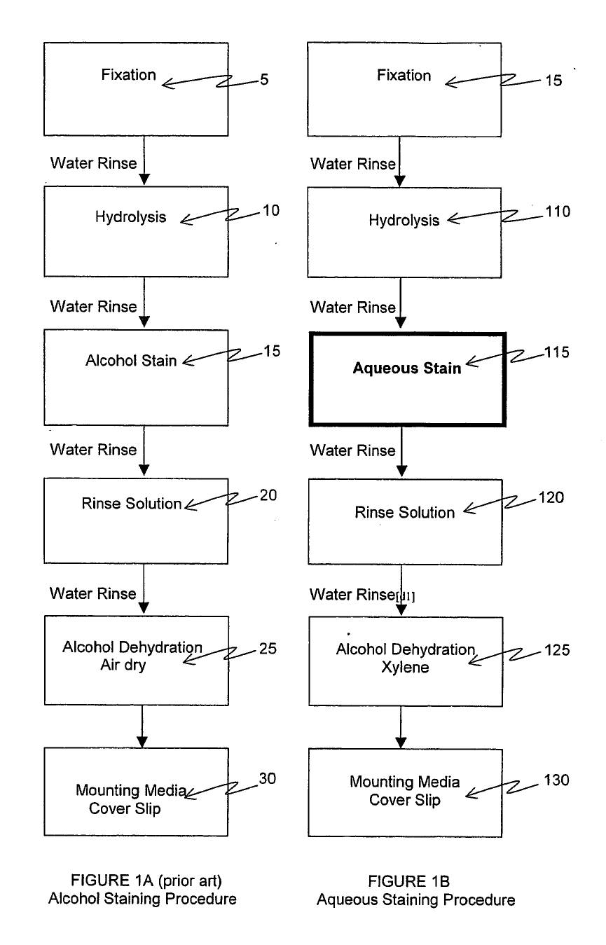

FIG. 1B schematically outlines a representative staining procedure of the preferred embodiment of the present invention, using the Feulgen reaction and using the aqueous staining reagent described above. The method as described assumes isolated intact cells have been deposited on microscope slides, but can be used with cells in other formats. For example, nuclear or cellular suspensions can be on a slide, in cell-cultured plates, in biological fluids, and in histological sections.

The steps of the preferred embodiment are:
Fixation of tissues in Bohm Sprenger's fixative for 45 minutes at 26° C. (step 115) (320 mL methanol, 60 mL 37% aqueous formaldehyde solution, 20 mL glacial acetic acid);
Distilled water rinse;
Acid hydrolysis in 5N hydrochloric acid for one hour at 26° C. (step 110);
Distilled water rinse;
Staining with aqueous thionin stain solution (step 115) (1.0 gram of thionin, 1.0 gram of sodium metabisulfite, 50 mL 1N hydrochloric acid, 450 mL distilled water stirred for one hour at 26° C., filter stain through No. 3. filter paper prior to use; immerse specimen in stain for 75 minutes);
Distilled water rinse;
Rinse solution (step 120) (7.5 grams sodium metabisulfite, 75 mL 1N hydrochloric acid, 1425 mL distilled water; three changes, 20 dips per dish of rinse);
Distilled water rinse;
Dehydration in three graded or 100% alcohol steps, air-dry slides (step 125);
Apply mounting media and cover slip (step 130)

A manual staining procedure may also be incorporated into an automated procedure. Automation is another way of promoting consistency over staining steps to reduce variation and difficulties in quantitative analysis.

In general, the reaction of thionin and metabisulfite forms active DNA binding ingredients when applied to DNA following hydrolysis. In this manner, the composition is useful for staining cellular DNA. For example, the composition of the invention is applied to cells to produce stained nuclei for the purpose of quantification. The composition may be utilized to stain cell preparations and histological sections for visualizing nuclear components or for quantifying DNA content. Examples of preparations include but are not limited to monolayers, cytocentrifuged preparations, exfoliated cells, smears, cultured cells, and isolated DNA. Cell preparations are advantageous by not necessitating invasive, complicated, expensive methods of retrieval

In another aspect, the above composition and staining steps in conjunction with optical density measurements of the resulting stained nuclei allow the presence and content of nuclear DNA to be determined. Instruments and processes for determining DNA content include those discussed in U.S. Pat. No. 6,026,174 to Palcic et al., System and method for automatically detecting malignant cells and cells having malignancy-associated changes, and “Increase of Sensitivity of Sputum Cytology Using High-Resolution Image Cytometry: Field Study Results” (Palcic and Garner et al., 2002), both of which are incorporated by reference.

Cell features can be digitally imaged and computer manipulated for analysis with respect to size, shape and nuclear DNA content. In particular chromatin texture and arrangement may be used to trace changes associated with diseases such as cancer. Techniques described in Doudkine, A., MacAulay, C., Poulin, N., Palcic, B. Nuclear Texture Measurements in Image Cytometry, Pathologica (1995) Vol. 87, pp. 286-299 (1995), are examples of how nuclear texture measurements can be applied to cancer screening.

Moreover, the composition and methods of the present invention can be used to assess euchromatin. Analysis of DNA distribution is described in United States Published Patent Application No. 2004/0092026, Method of identifying and assessing DNA euchromatin in biological cells for detecting disease, monitoring wellness, assessing bio-activity, and screening pharmacological agents, the disclosure of which is incorporated herein by reference. The DNA can be stained using the methods and compositions disclosed herein for the analytical procedures described in that application.

Another aspect of the invention provides a cellular DNA staining kit as hereinafter described. Components are contained in one or more vessels within the kit, in dry or liquid form. Microscope slides and reference slides having material (such a cell lines, standards, controls etc.) are preferably included. The reference materials may include cells or materials used to monitor or otherwise assess DNA staining. In the case of DNA analysis, this material may include but is not limited to various cultured cell lines, nuclei, isolated DNA, and cell or histological samples of human or animal origin. The kit may also contain an instructional booklet providing information and directions for using kit contents and associated staining procedures.

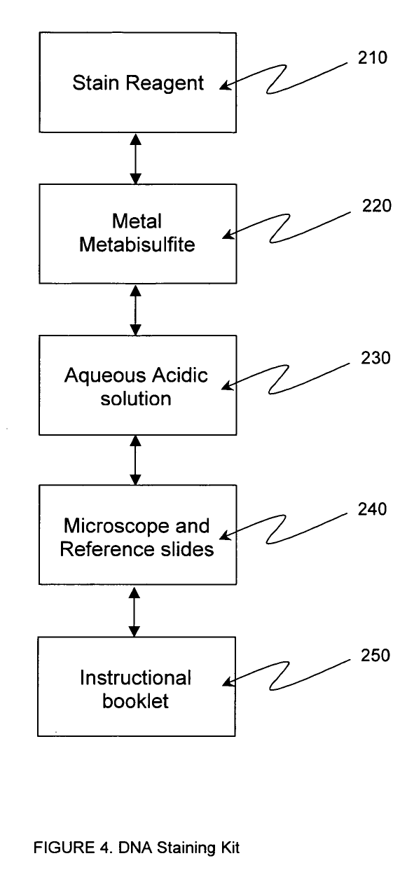

A cellular DNA staining kit 200, a box containing one or more vessels containing dry or liquid reagents, is shown in FIG. 4. In one embodiment, the kit contains a stain 210, preferably thionin, in either solid or concentrated liquid form, and a metal metabisulfite 220, preferably sodium or potassium metabisulfite and most preferably sodium metabisulfite, which is usually a white crystalline solid. Preferably, the stain 210 and the metabisulfite 220 are supplied in amounts sufficient to create the weight-to-volume ratios and molar concentrations described above. The kit 200 can contain an acid 230, or the user can be required to provide one. If the kit contains an acid 230, it is supplied in tan amount effective to produce the pH described above. Most laboratories will have an acid on hand, in which case the instructions 260 inform the user of the proper amount to use and the proper pH range. Preferably, the kit 200 contains a mixing vessel also, although the user may be required to supply one. The kit 200 also contains at least one microscope slide 240 and at least one reference slide 250. The user combines the stain 210, the metabisulfite 220, and the acid 230 and mixes to create an aqueous staining reagent.

In another embodiment, the acid 230 is contained in a vessel containing an acidic water solution of sufficient volume to mix the stain 210 and the metabisulfite 220 to the weight-to-volume ratios and molar concentrations described above and to produce the pH described above is In this embodiment, the user mixes the stain 210 (either solid or concentrated liquid) and the metabisulfite 220 (powder) into the vessel and mixes for a time period, preferably one hour, to create an aqueous staining reagent.

In another embodiment, the metabisulfite 220 is supplied as a powder and the stain 210 is supplied in a vessel containing a water solution of sufficient volume to mix create the weight-to-volume ratios described above. The water solution can be acidic already, or the user can be instructed to supply acid to create the pH described above.

In yet another embodiment, the stain 210 is supplied as a powder and the metabisulfite is supplied in a vessel containing a water solution of sufficient volume to mix create the weight-to-volume ratios described above. The water solution can be acidic already, or the user can be instructed to supply acid to create the pH described above.

In the described embodiments, the kit 200 also contains microscope slides 240 and reference slides 250, having material such a cell lines, standards, or controls used to monitor or otherwise assess DNA staining. In the case of DNA analysis, this material may include but is not limited to various cultured cell lines, nuclei, isolated DNA, and cell or histological samples of human or animal origin. The kit may also contain instructional booklet 260 providing information and directions for using kit contents and associated staining procedures.

The kit 200 optionally contains a separate vessel containing a rinse solution. The rinse solution is used for step 120 described above. The rinse solution preferably is made from 7.5 grams sodium metabisulfite, 75 mL; 1N hydrochloric acid, and 1425 mL distilled water, or other quantities of effective ratios. Other rinse solutions known in the art can be used.

In use, the user fixes a specimen to a slide. The slide and the reference slide are both stained in the aqueous staining reagent for a predetermined amount of time, then are removed and rinsed according to the method described above. The stained specimen can then be compared to the reference slide by a suitable method, such as visual inspection, image cytometry, optic density analysis, or other analytical tool.

While preferred embodiments of the present invention are shown and described, it is envisioned that those skilled in the art may devise various modifications of the present invention without departing from the spirit and scope.

1. A staining reagent composition comprising an aqueous solution of a stain, an acid, and sodium metabisulfite, wherein said stain has a weight to volume ratio in said aqueous solution in the range of 0.05 to 0.6 percent, said sodium metabisulfite has a weight to volume ratio in said aqueous solution in the range of 0.05 to 2.4 percent, and said aqueous solution h as a pH in the range of about 1.3 to 1.5.

2. The composition of claim 1, wherein said stain comprises at least one of thionin, Azure A, Azure B, Azure C, sym-dimethylthionine, pararosanilin, methylene blue, fuchsin, hematoxylin, acridine orange, and methyl green.

3. (canceled)

4. The composition of claim 1, wherein said stain is thionin and said thionin has a weight to volume ratio in said aqueous solution of about 0.2 percent and said sodium metabisulfite has a weight to volume ratio in said aqueous solution of about 0.2 percent.

5. (canceled)

6. (canceled)

7. (canceled)

8. A method of making a staining reagent composition, comprising the steps of:
mixing an acid, a stain, and sodium metabisulfite into water to form an aqueous solution; and
removing particulate matter from said aqueous solution;
wherein said stain has a weight to volume ratio in said aqueous solution in the range of 0.05 to 0.6 percent, said sodium metabisulfite has a weight to volume ratio in said aqueous solution in the range of 0.05 to 2.4 percent, and said aqueous solution has a pH in the range of about 1.3 to 1.5.

9. The method of claim 8, wherein said stain comprises at least one of thionin, Azure A, Azure B, Azure C, sym-dimethylthionine, pararosanilin, methylene blue, fuchsin, hematoxylin, acridine orange, and methyl green.

10. (canceled)

11. The composition of claim 8, wherein said stain is thionin and said thionin has a weight to volume ratio in said aqueous solution of about 0.2 percent and said sodium metabisulfite has a weight to volume ratio in said aqueous solution of about 0.2 percent.

12. (canceled)

13. (canceled)

14. (canceled)

15. (canceled)

16. The method of claim 8, further comprising maintaining said acid and said water at a temperature in the range of about 24° C. to 27° C. before said mixing step.

17. The method of claim 8, further comprising maintaining said acid and said water at a temperature of about 26° C. before said mixing step.

18. The method of claim 8, further comprising maintaining said aqueous solution at a temperature in the range of about 24° C. to 27° C. during said mixing step.

19. The method of claim 8, further comprising maintaining said aqueous solution at a temperature of about 26° C. during said mixing step.

20. A method of staining cells for image cytometry, comprising:
fixing tissue comprising at least one cell;
hydrolyzing said tissue;
staining said tissue with an aqueous solution comprising an acid, a stain, and sodium metabisulfite;
rinsing said tissue; and
dehydrating said tissue;
wherein said stain has a weight to volume ratio in said aqueous solution in the range of 0.05 to 0.6 percent, said sodium metabisulfite has a weight to volume ratio in said aqueous solution in the range of 0.05 to 2.4 percent, and said aqueous solution has a pH in the range about 1.3 to 1.5.

21. The method of claim 20, wherein said stain comprises at least one of thionin, Azure A, Azure B. Azure C, sym-dimethylthionine, pararosanilin, methylene blue, fuchsin, hematoxylin, acridine orange, and methyl green.

22. (canceled)

23. The method of claim 20, wherein said stain is thionin and said thionin has a weight to volume ratio in said aqueous solution of about 0.2 percent and said sodium metabisulfite has a weight to volume ratio in said aqueous solution of about 0.2 percent.

24. (canceled)

25. (canceled)

26. (canceled)

27. The method of claim 20, wherein said tissue comprises at least one of filtered monolayers of cells, cytocentrifuged cells, exfoliated cells, smears, cultured cells, and isolated DNA.

28. The method of claim 20, further comprising measuring an optical density of said at least one cell.

29. The method of claim 20, further comprising obtaining an image of said at least one cell and analysing said image.

30. The method of claim 29, wherein said analysing step comprises assessing at least one of size, shape, and nuclear DNA content of said at least one cell.

31. The method of claim 20, wherein said analysing step comprises assessing at least one of chromatin and euchromatin of said at least one cell.

32. A kit comprising:
a vessel containing a staining reagent comprising an aqueous solution of a stain, an acid, sodium metabisulfite, and water, said stain having a weight to volume ratio in said aqueous solution in the range of 0.05 to 0.6 percent, said sodium metabisulfite having a weight to volume ratio in said aqueous solution in the range of 0.05 to 2.4 percent, and said aqueous solution having a pH in the range of about 1.3 to 1.5;
a slide; and
a separate reference slide; whereby a specimen placed on said slide can be stained, rinsed, and compared to said reference slide.

33. The kit of claim 32, wherein said stain comprises at least one of thionin, Azure A, Azure B, Azure C, sym-dimethylthionine, pararosanilin, methylene blue, fuchsin, hematoxylin, acridine orange, and methyl green.

34. (canceled)

35. The kit of claim 32, wherein said stain is thionin and said thionin has a weight to volume ratio in said aqueous solution of about 0.2 percent and said sodium metabisulfite has a weight to volume ratio in said aqueous solution of about 0.2 percent.

36. (canceled)

37. (canceled)

38. (canceled)

39. The kit of claim 32, wherein said at least one reference slide comprises at least one of a cultured cell line, a histological sample, nuclei, and isolated DNA.

40. The kit of claim 32, further comprising a second vessel containing a rinse solution.

41. The kit of claim 32, further comprising instructions for use.

42. A kit comprising:
a stain;
sodium metabisulfite, whereby said stain and said sodium metabisulfite can be mixed with an acid and a predetermined amount of water to create an aqueous solution comprising an aqueous staining reagent composition having a weight to volume ratio of said stain in said aqueous solution in the range of 0.05 to 0.6 percent, a weight to volume ratio of said sodium metabisulfite in said aqueous solution in the range of 0.05 to 2.4 percent, and a pH in the range of about 1.3 to 1.5;
a slide; and
a separate reference slide; whereby a specimen placed on said slide can be stained in said aqueous staining reagent, rinsed, and compared to said reference slide.

43. The kit of claim 42, wherein said stain comprises at least one of thionin Azure A, Azure B, Azure C, sym-dimethylthionine, pararosanilin, methylene blue, fuchsin, hematoxylin, acridine orange, and methyl green.

44. The kit of claim 42, wherein said stain comprises thionin and said weight to volume ratio of said thionin in said aqueous solution is about 0.2 percent and said weight to volume ratio of said sodium metabisulfite in said aqueous solution is about 0.2 percent.

45. (canceled)

46. (canceled)
